(19) United States
(12) Patent Application Publication
(10) Pub. No.: US 2024/0402993 A1
(43) Pub. Date: Dec. 5, 2024

(54) DETERMINING SHARED EXPONENT VALUES FOR SHARED EXPONENT FLOATING POINT DATA TYPES

(71) Applicant: Microsoft Technology Licensing, LLC, Redmond, WA (US)

(72) Inventors: Rasoul SHAFIPOUR, Bellevue, WA (US); Bita DARVISH ROUHANI, Bellevue, WA (US); Marius Octavian STAN, Redmond, WA (US); Mathew Kent HALL, Redmond, WA (US); Preyas Janak SHAH, Tampa, FL (US); Ankit MORE, San Mateo, CA (US); Eric Sen CHUNG, Woodinville, CA (US); Douglas C. BURGER, Bellevue, WA (US)

(21) Appl. No.: 18/325,917

(22) Filed: May 30, 2023

(51) Int. Cl. G06F 7/483; G06F 7/556

(52) U.S. Cl. CPC G06F 7/483; G06F 7/556

(57) ABSTRACT

Embodiments of the present disclosure include systems and methods for determining shared exponent values for shared exponent floating point data types. A device may determine a shared global exponent value for a plurality of floating point numbers. The device may determine a sub exponent value from a plurality of candidate sub exponent values that minimizes a quantization error value determined based on a subset of the plurality of floating point numbers and a version of the subset of the plurality of floating point numbers quantized based on the shared global exponent and the sub exponent value. The determined sub exponent value is shared among the subset of the plurality of floating point numbers. The device may, based on the sub exponent value, represent the subset of the plurality of floating point numbers using a shared exponent floating point data type.

### BACKGROUND

The present disclosure relates to floating point data types. More particularly, the present disclosure relates to selecting shared exponent values for shared exponent floating point data types.

A neural network is a machine learning model used for a variety of different applications (e.g., image classification, computer vision, natural language processing, speech recognition, writing recognition, etc.). A neural network may be trained for a particular purpose by running datasets through it, comparing results from the neural network to known results, and updating the network based on the differences.

Efficient training of neural networks and using neural networks for inference at low fidelity data types may require developing data types that maximize the fidelity of each bit while minimizing the computing cost. This can be formulated as an optimization problem where the goal is to maximize a quantization signal to noise ratio (QSNR) metric while minimizing the area overhead of hardware dot-product units.

### BRIEF DESCRIPTION OF THE DRAWINGS

Various embodiments of the present disclosure are illustrated by way of example and not limitation in the figures of the accompanying drawings.

FIG. 1 illustrates a system for determining shared exponent values for shared exponent floating point data types according to some embodiments.

FIG. 2 illustrates an example definition of a shared exponent floating point data type according to some embodiments.

FIG. 3 illustrates an example exponent selection graph for determining shared exponent values according to some embodiments.

FIG. 4 illustrates another example exponent selection graph for determining shared exponent values according to some embodiments.

FIG. 5 illustrates a process for determining a shared exponent value for a shared exponent floating point data type according to some embodiments.

FIG. 7 depicts a simplified block diagram of an example computer system according to some embodiments.

FIG. 8 illustrates a neural network processing system according to some embodiments.

### DETAILED DESCRIPTION

In the following description, for purposes of explanation, numerous examples and specific details are set forth in order to provide a thorough understanding of the present disclosure. Such examples and details are not to be construed as unduly limiting the elements of the claims or the claimed subject matter as a whole. It will be evident to one skilled in the art, based on the language of the different claims, that the claimed subject matter may include some or all of the features in these examples, alone or in combination, and may further include modifications and equivalents of the features and techniques described herein.

Described herein are techniques for determining shared exponent values for shared exponent floating point data types. In some embodiments, a device (e.g., a computing device, a hardware accelerator, etc.) may be configured to manage floating point numbers. For example, the device may organize floating point numbers into blocks of floating point numbers and store them using a shared exponent floating point data type. In some embodiments, for a block of floating point numbers that are stored according to a shared exponent floating point data type, the exponent values of the floating point numbers in the block are represented using a set of shared exponent values. Each of the shared exponent values are shared among two or more floating point numbers in the block. In some cases, a shared exponent value is shared among all of the floating point numbers in the block. In other cases, a shared exponent value is shared among some of the floating point numbers in the block. To determine the value of a shared exponent that is to be shared among several floating point numbers, the device selects the value for the shared exponent such that the quantization error between the mantissa values of the floating point numbers and the mantissa values of the floating point numbers quantized based on the value of the shared exponent is minimized. This technique can be utilized for determining the value for a shared exponent value that is shared among all of the floating point numbers in the block, determining the value for a shared exponent value is shared among some of the floating point numbers in the block, or both.

The techniques described in the present application provide a number of benefits and advantages over conventional methods for determining shared exponent values for shared exponent floating point data types. For instance, selecting the value for a shared exponent that is to be shared among several floating point numbers in a manner that minimizes the quantization error between the floating point numbers and the quantized floating point numbers produces higher numerical fidelity compared to conventional shared exponent floating point data types. This advantage is useful in artificial intelligence (AI) and machine learning (ML) technologies where floating point numbers are used in large neural network models. Representing floating point numbers, especially narrow bit-width floating point numbers (e.g., floating point numbers with 1-4 bits of mantissa), using an optimized shared exponent floating point data type that has higher numerical fidelity translates to increased efficiency and accuracy in the training of the neural network models and the use of the neural network models for inferencing.

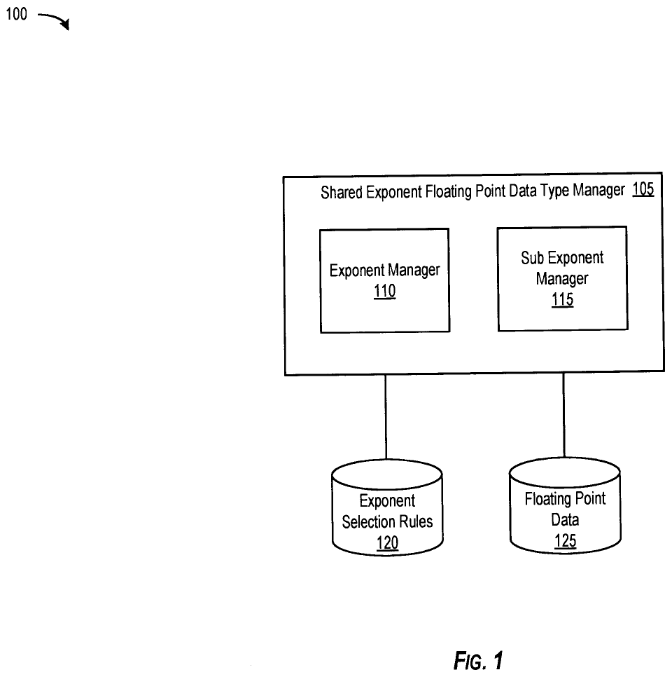

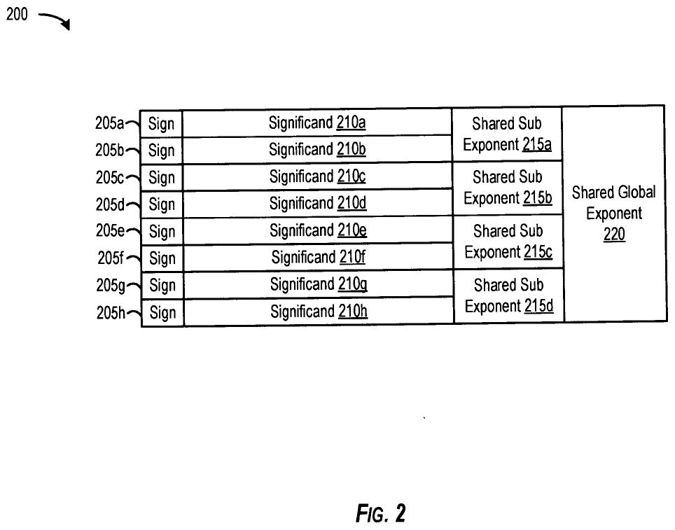

FIG. 1 illustrates a system 100 for determining shared exponent values for shared exponent floating point data types according to some embodiments. In some embodiments, system 100 may be implemented in a computing device (e.g., a computer system, a data processing system, etc.) as a set of instructions (e.g., a program, an application) executed by a processing unit of the computing device. In other embodiments, system 100 can be implemented in a hardware accelerator (e.g., an AI accelerator) as a set of circuits, for example. As shown, system 100 includes shared exponent floating point data type manager 105, exponent selection rules storage 120, and floating point data storage 125. Exponent selection rules storage 120 is configured to store rules for selecting a value for a shared exponent. Floating point data storage 125 stores floating point data. Examples of such floating point data include shared exponent floating point data type definitions, instances of shared exponent floating point data types, floating point numbers, etc.

FIG. 2 illustrates an example structure of a shared exponent floating point data type 200 according to some embodiments. For this example, shared exponent floating point data type 200 is used to represent eight floating point numbers. The eight floating point numbers can be referred to collectively as a block of floating point numbers. As illustrated, shared exponent floating point data type 200 includes signs 205a-h, significands 210a-h, shared sub exponents 215a-d, and shared global exponent 220. Each of the signs 205a-h is the sign value of a respective floating point number. Each of the corresponding significands 210a-h is the significand value of the respective floating point number. Each of the shared sub exponents 215a-d is an exponent value that is shared between two floating point numbers. Each group of two floating point numbers that share the same sub exponent value may be referred to as a sub block of floating point numbers. As shown in FIG. 2, the floating point numbers with significands 210a and 210b share the same shared sub exponent 215a, the floating point numbers with significands 210c and 210d share the same sub exponent 215b, the floating point numbers with significands 210e and 210f share the same sub exponent 215c, and the floating point numbers with significands 210g and 210h share the same sub exponent 215d. Significands 210a-d share shared main exponent 220a while significands 210e-h share shared main exponent 220b. Shared global exponent 220 is an exponent value that is shared among each floating point number in the block of floating point numbers.

In this example, shared exponent floating point data type 200 employs two levels of shared exponent values to represent an exponent of a floating point number. Each of the shared sub exponents 215a-d is an exponent value that is subtracted from shared global exponent 220, which is another exponent value, to determine the actual exponent value for representing a floating point number. For instance, to determine the actual exponent value for the floating point number with significand 210a, shared sub exponent 215a is subtracted from shared global exponent 220. As another example, to determine the actual exponent value for the floating point number with significand 210h, shared sub exponent 215d is subtracted from shared global exponent 220.

FIG. 2 depicts an example structure of a shared exponent floating point data type. One of ordinary skill in the art will appreciate that different shared exponent floating point data types can have different structures (e.g., different levels of shared exponent values, different sub block sizes (e.g., four floating point numbers in each sub block), several first level shared exponents instead of a shared global exponent, etc. Regardless of the structure of the shared exponent floating point data type used to represent a block of floating point numbers, the techniques described herein may be used to determine values for one or more shared exponents.

Returning to FIG. 1, shared exponent floating point data type manager 105 is responsible for managing shared exponent floating point data types. As shown, shared exponent floating point data type manager 105 includes exponent manager 110 and sub exponent manager 110. Shared exponent floating point data type manager 105 can represent floating point numbers using a shared exponent floating point data type. Referring to FIG. 2 as an example, shared exponent floating point data type manager 105 accesses floating point data storage 125 to retrieve eight floating point numbers to be represented using shared exponent floating point data type 200.

Next, shared exponent floating point data type manager 105 sends exponent manager 110 the floating point numbers and a request to determine a shared global exponent value for the floating point numbers. In return, shared exponent floating point data type manager 105 receives an exponent value that is to be shared among the eight floating point numbers. Shared exponent floating point data type manager 105 groups the eight floating point numbers into four sub blocks of two floating point numbers. Shared exponent floating point data type manager 105 then sends sub exponent manager 115 the four sub blocks of floating point numbers, the shared global exponent value, and a request to determine a shared sub exponent value for each of the sub blocks of floating point numbers.

After shared exponent floating point data type manager 105 receives the shared sub exponent values from sub exponent manager 115, shared exponent floating point data type manager 105 generates an instance of shared floating point data type 200. Then, shared exponent floating point data type manager 105 stores the global shared exponent value as shared global exponent 220 and the shared sub exponent values in the corresponding shared sub exponents 215a-d. In addition, shared exponent floating point data type manager 105 stores the sign values and mantissa values of the floating point numbers in the corresponding signs 205a-h and significands 210a-h. Finally, shared exponent floating point data type manager 105 stores the instance of the shared exponent floating point data type 200 in floating point data storage 125.

In addition to creating new instances of a shared exponent floating point data type to represent floating point numbers, shared exponent floating point data type manager 105 may also apply the techniques described herein to optimize existing instances of shared exponent floating point data types that have shared exponent values determined using different methods. For example, floating point data storage 125 can store such instances of shared exponent floating point data type 200. To optimize one of these instances of shared exponent floating point data type 200, shared exponent floating point data type manager 105 can access floating point data storage 125 to retrieve the instance. Next, shared exponent floating point data type manager 105 sends sub exponent manager 115 the four sub blocks of floating point numbers stored in the instance, the shared global exponent value stored in the instance, and a request to determine a shared sub exponent value for each of the sub blocks of floating point numbers. Upon receiving the shared sub exponent values from sub exponent manager 115, shared exponent floating point data type manager 105 replaces the existing shared sub exponent values in the instance of shared floating point data type 200 with the new ones received from sub exponent manager 115.

Exponent manager 110 is configured to determine shared global exponents for floating point numbers. For instance, exponent manager 110 may receive from shared exponent floating point data type manager 105 several floating point numbers and a request to determine a shared global exponent value for the floating point numbers. In response, exponent manager 110 determines an exponent value that is shared among the floating point numbers. In some embodiments, exponent manager 110 determines the absolute value of each of the floating point numbers. Then, exponent manager 110 selects the floating point number that has the highest absolute value. Exponent manager 110 determines an exponent value where that the selected floating point number is greater than to 2^{e} and less than 2^{e+1}. Exponent manager 110 uses this determined exponent value as the shared global exponent that is to be shared among each of the floating point numbers. In some embodiments, instead of using the aforementioned maximum absolute value approach, exponent manager 110 can use the techniques employed by sub exponent manager 115 to determine the shared global exponent for the floating point numbers. Once exponent manager 110 determines the shared global exponent for the floating point numbers, exponent manager 110 sends the shared global exponent to shared exponent floating point data type manager 105.

Sub exponent manager 115 handles the determination of shared sub exponents for sub blocks of floating point numbers. For example, sub exponent manager 115 may receive from shared exponent floating point data type manager 105 sub blocks of floating point numbers, a shared global exponent value that is to be shared among each of the floating point numbers, and a request to determine shared sub exponent values for each sub block of floating point numbers. In response to the request, sub exponent manager 115 determines a shared sub exponent value for each sub block of floating point numbers.

To determine a shared sub exponent value for a sub block of floating point numbers, sub exponent manager 115 selects a sub exponent value from several candidate sub exponent values to be the shared sub exponent value for the floating point numbers in the sub block. The candidate sub exponent values are based on the total number of possible values that can be represented by the shared sub exponent value (e.g., the total number of possible values that can be represented by a shared sub exponent 215). For instance, if the number of bits used to store a shared sub exponent value is one bit, then the candidate sub exponent values are 0 and 1. If the number of bits used to store a shared sub exponent value is two bits, then the candidate sub exponent values are 0, 1, 2, and 3. Sub exponent manager 115 selects the sub exponent value from the candidate sub exponent values that minimizes the quantization error between the floating point numbers and a version of the floating point numbers quantized based on the shared global exponent value and the sub exponent value.

Several examples of selecting sub exponent values by minimizing quantization errors will now be described. For these examples, shared exponent floating point data type 200 will be used. Therefore, the sub block size is two (i.e., each sub block includes a sub exponent value that is shared between two floating point numbers). Also, assume that the mantissa bit width is two (i.e., the number of bits used to represent mantissa values is two), the shared sub exponent bit width is one (i.e., the number of bits used to represent a shared sub exponent value is one), and exponent manager 110 has determined the value of the shared global exponent to be 1. Based on these assumptions, the following Table 1 illustrates the quantization values for a 2-bit mantissa and a 1-bit shared sub exponent:

TABLE 1

| Actual Exponent = 0 | Actual Exponent = 1 |
|---|---|
| Shared Global Exponent = 1 | Shared Global Exponent = 1 |
| Sub Exponent = 1 | Sub Exponent = 0 |
| 1.1 * 2\hat{ }0 = 1.5 | 1.1 * 2\hat{ }1 = 3 |
| 1.0 * 2\hat{ }0 = 1 | 1.0 * 2\hat{ }1 = 2 |
| 0.1 * 2\hat{ }0 = 0.5 | 0.1 * 2\hat{ }1 = 1 |
| 0.0 * 2\hat{ }0 = 0 | 0.0 * 2\hat{ }1 = 0 |

As mentioned above by reference to FIG. 2, the actual exponent value for representing a floating point number is determined by subtracting the shared sub exponent value from the shared global exponent value. As shown in the left column of Table 1, the binary value of 1.1 multiplied by an actual exponent of 0 is equal to a decimal value of 1.5, the binary value of 1.0 multiplied by an actual exponent of 0 is equal to a decimal value of 1, the binary value of 0.1 multiplied by an actual exponent of 0 is equal to a decimal value of 0.5, and the binary value of 0.0 multiplied by an actual exponent of 0 is equal to a decimal value of 0. The right column of Table 1 shows the binary value of 1.1 multiplied by an actual exponent of 1 is equal to a decimal value of 3, the binary value of 1.0 multiplied by an actual exponent of 1 is equal to a decimal value of 2, the binary value of 0.1 multiplied by an actual exponent of 1 is equal to a decimal value of 1, and the binary value of 0.0 multiplied by an actual exponent of 1 is equal to a decimal value of 0.

For a first example of selecting a sub exponent value by minimizing quantization errors, assume a sub-block of two floating point numbers includes the following binary values for the mantissas: [1.111, 1.111]. These values in decimal are [1.875, 1.875]. If the shared sub exponent value of 0 is selected from the candidate sub exponent values of 0 and 1 to be the shared sub exponent for the sub block, the actual exponent value for the sub block would be 1 (i.e., 1-0). The mantissas of the floating point numbers are quantized down to two bits in order to fit in the 2-bit wide mantissa of shared exponent floating point data type 200. Thus, the quantized version of the mantissas of the floating point values in binary would be [1.0, 1.0]. Based on Table 1, the quantized version of the floating point values in decimal values is [2, 2]. For this example, the quantization error is determined using a mean squared error approach, as shown in the following equation (1):

$${error}_{q} = \frac{1}{n} {\sum }_{i = 1}^{n} {( {X}_{i} - {\hat{X}}_{i} )}^{2}$$

where error_{q} is the quantization error value, n is the sub block size, Xᵢ is the original floating point value, and [symbol] is the quantized floating point value. Based on equation (1), the quantization error is 0.015625. Now, if the shared sub exponent value of 1 is selected from the candidate sub exponent values of 0 and 1 to be the shared sub exponent for the sub block, the actual exponent value for the sub block would be 0 (i.e., 1-1). The quantized version of the mantissas of the floating point values in binary would be [1.1, 1.1]. Based on Table 1, the quantized version of the floating point values in decimal values is [1.5, 1.5]. Based on equation (1), the quantization error here is 0.140625. For this first example, selecting a shared sub exponent value of 0 would minimize the quantization error since it produced the lower quantization error value.

For a second example of selecting a sub exponent value by minimizing quantization errors, assume a sub-block of two floating point numbers includes the following binary values for the mantissas: [1.111, 1.1]. The values here in decimal are [1.875, 1.5]. If the shared sub exponent value of 0 is selected from the candidate sub exponent values of 0 and 1 to be the shared sub exponent for the sub block, the actual exponent value for the sub block would be 1 (i.e., 1-0). The quantized version of the mantissas of the floating point values in binary would be [1.0, 1.0]. Based on Table 1, the quantized version of the floating point values in decimal values is [2, 2]. Based on equation (1), the quantization error is 0.1328125.

Continuing with the second example, if the shared sub exponent value of 1 is selected from the candidate sub exponent values of 0 and 1 to be the shared sub exponent for the sub block, the actual exponent value for the sub block would be 0 (i.e., 1-1). The quantized version of the mantissas of the floating point values in binary would be [1.1, 1.1]. Based on Table 1, the quantized version of the floating point values in decimal values is [1.5, 1.5]. Based on equation (1), the quantization error here is 0.0703125. For the second example, selecting a shared sub exponent value of 1 would minimize the quantization error since it produced the lower quantization error value.

In some embodiments, sub exponent manager 115 does not actually iterate through each of the possible shared sub exponent values, calculate their corresponding quantization error values, and then compare the various quantization error values to determine the shared sub exponent value that minimizes the quantization error value (e.g., produces the lowest quantization error value). Instead, sub exponent manager 115 uses a set of rules to determine a shared sub exponent value for a sub block of floating point numbers. Specifically, sub exponent manager 115 adjusts each floating point number in the sub block based on the shared global exponent. In some embodiments, sub exponent manager 115 adjust a floating point number in a sub block based on the shared global exponent by performing a number of right shift operations on the mantissa value of the floating point number equal to the value of the shared global exponent. For example, if the shared global exponent has a value of five, then sub exponent manager 115 would perform four right shift operation on the mantissa value of the floating point number. Based on the adjusted floating point numbers, sub exponent manager 115 applies the set of rules. For a given set of adjusted floating point numbers, the set of rules are configured to specify the sub exponent value that minimizes the quantization error (e.g., produces the smallest quantization error value).

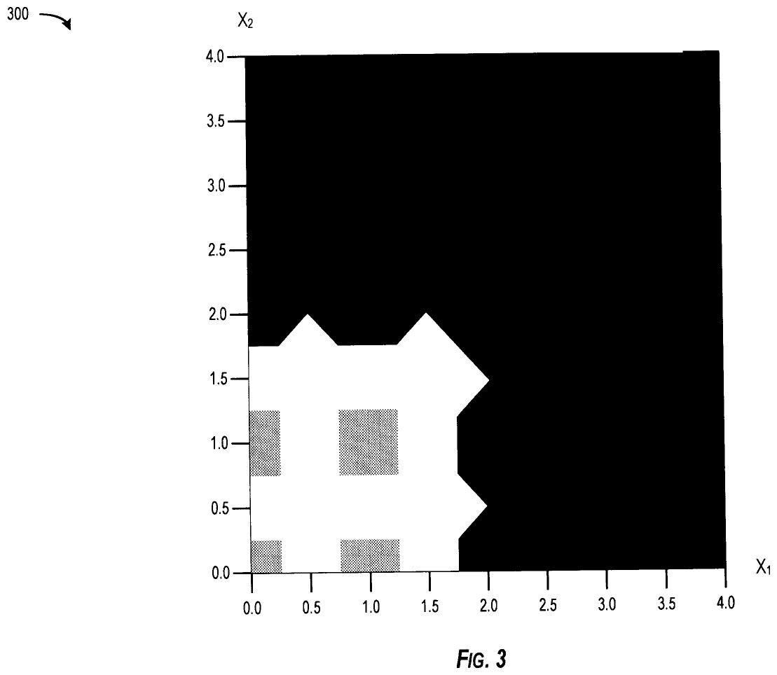

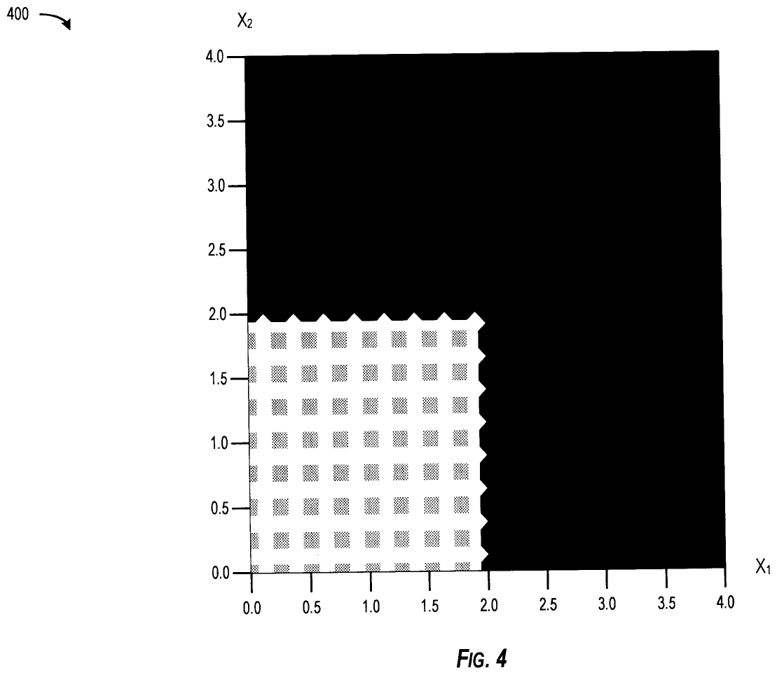

FIG. 3 illustrates an example exponent selection graph 300 for determining shared exponent values according to some embodiments. In particular, decision graph 300 conceptually illustrates which sub exponent value to select as the shared sub exponent value for two floating point numbers (i.e., a sub block size of two) where the bit width of a shared sub exponent value is one bit (i.e., the candidate sub exponent values are 0) and 1) and the bit width of a mantissa value is two bits. As shown, exponent selection graph 300 includes an x-axis that corresponds to one of the adjusted floating point values (X₁) and a y-axis that corresponds to the other adjusted floating point value (X₂). The coordinates of a point represented by the unsigned adjusted values of the floating point numbers indicate which sub exponent value minimizes the quantization error. In this example, the black area of exponent selection graph 300 indicates that a sub exponent value of 0 minimizes the quantization error, the white area of exponent selection graph 300 indicates that a sub exponent value of 1 minimizes the quantization error, and the gray area of exponent selection graph 300 indicates that a sub exponent value of 0) and 1 each equally produces the same quantization error (thus, either value can be used).

FIG. 4 illustrates another example exponent selection graph 400 for determining shared exponent values according to some embodiments. Specifically, decision graph 400 conceptually illustrates which sub exponent value to select as the shared sub exponent value for two floating point numbers (i.e., a sub block size of two) where the bit width of a shared sub exponent value is one bit (i.e., the candidate sub exponent values are 0 and 1) and the bit width of a mantissa value is four bits. As depicted in FIG. 4, exponent selection graph 400 includes an x-axis that corresponds to one of the adjusted floating point values (X₁) and a y-axis that corresponds to the other adjusted floating point value (X₂). The coordinates of a point represented by the unsigned adjusted values of the floating point numbers indicate which sub exponent value minimizes the quantization error. Similar to FIG. 3, the black area of exponent selection graph 400 indicates that a sub exponent value of 0 minimizes the quantization error, the white area of exponent selection graph 400 indicates that a sub exponent value of 1 minimizes the quantization error, and the gray area of exponent selection graph 400 indicates that a sub exponent value of 0 and 1 each equally produces the same quantization error (thus, either value can be used).

FIGS. 3 and 4 illustrate examples of exponent selection graphs for determining sub exponent values for sub blocks of floating point numbers based on adjusted floating point values. One of ordinary skill in the art will understand that the same concept shown in these examples can be applied for different sized sub blocks, different bit widths for shared sub exponent values, different bit widths for mantissa values, etc. Moreover, the logic for determining which sub exponent value to select for sub blocks of floating point numbers that is visually depicted in FIGS. 3 and 4 can be defined in the form of rules. In some embodiments, these may be the set of rules mentioned above, which sub exponent manager 115 uses, that are configured to specify the sub exponent value that minimizes the quantization error for a given set of adjusted floating point numbers.

The examples explained above by reference to FIGS. 1-4 describe how to determine shared sub exponent values for a shared exponent floating point data type. One of ordinary skill in the art will understand that the same or similar techniques can be applied to shared scale floating point data types as well. For instance, a shared scale floating point data type may have a shared exponent accompanied by a shared significand. The techniques described above for determining a shared exponent value can also be employed to select a shared exponent and/or significand for the shared scale floating point data type. Additionally, the examples explained above by reference to FIGS. 1-4 describe how a mean squared error metric can be used to determine shared sub exponent values for a shared exponent floating point data type. One of ordinary skill in the art will appreciate that additional and/or different metrics may be used to determine shared sub exponent values for a shared exponent floating point data type in different embodiments. For example, a mean absolute error approach can be utilized instead of the mean squared error approach.

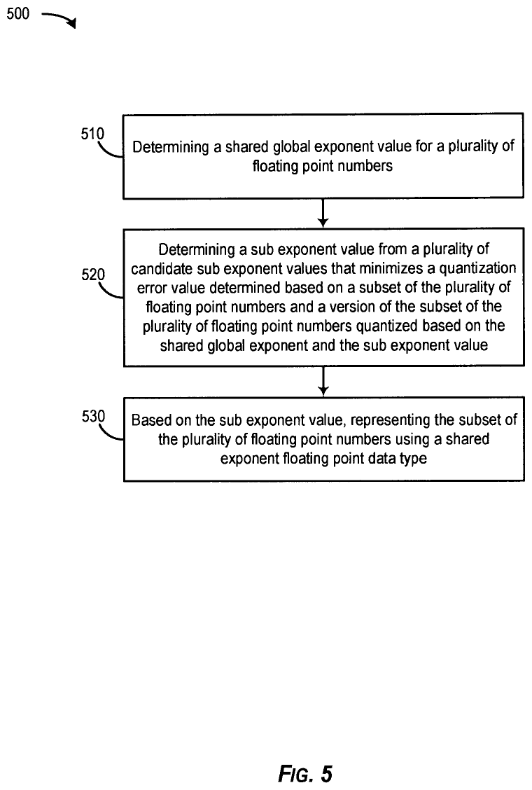

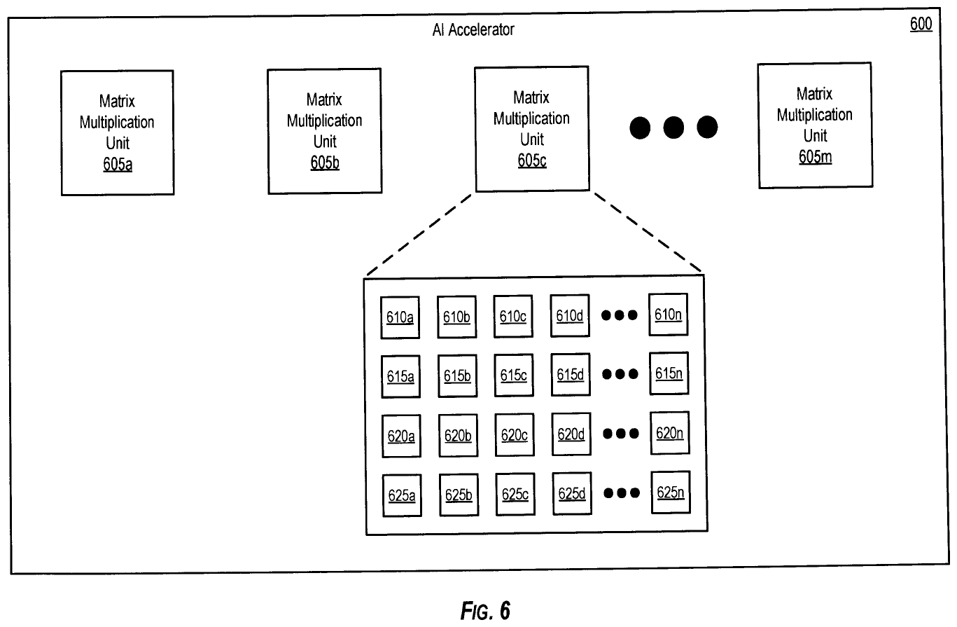

FIG. 5 illustrates a process 500 for determining a shared exponent value for a shared exponent floating point data type according to some embodiments. In some embodiments, shared exponent floating point data type manager 105 performs process 500. Process 500 begins by determining, at 510, a shared global exponent value for a plurality of floating point numbers. Referring to FIGS. 1 and 2 as an example, shared exponent floating point data type manager 105 may access floating point data storage 125 to retrieve eight floating point numbers to be represented using shared exponent floating point data type 200. Then, shared exponent floating point data type manager 105 sends exponent manager 110 the floating point numbers and a request to determine a shared global exponent value for the floating point numbers. In response, exponent manager 110 determines a shared global exponent that is to be shared among each of the floating point numbers and sends it to shared exponent floating point data type manager 105.

Next, process 500 determines, at 520, a sub exponent value from a plurality of candidate sub exponent values that minimizes a quantization error value determined based on a subset of the plurality of floating point numbers and a version of the subset of the plurality of floating point numbers quantized based on the shared global exponent and the sub exponent value. The determined sub exponent value is shared among the subset of the plurality of floating point numbers. Referring to FIGS. 1 and 2 as an example, sub exponent manager 115 selects a sub exponent value from several candidate sub exponent values to be the shared sub exponent value for the subset of the plurality of floating point numbers (e.g., floating point numbers in a sub block). The selected sub exponent value minimizes the quantization error between the floating point numbers and a version of the floating point numbers quantized based on the shared global exponent value and the sub exponent value.

Finally, based on the sub exponent value, process 500 represents, at 530, the subset of the plurality of floating point numbers using a shared exponent floating point data type. Representing, based on the sub exponent value, the subset of the plurality of floating point numbers using the shared exponent floating point data type results in higher numerical fidelity of the subset of the plurality of floating point numbers. Referring to FIGS. 1 and 2 as an example, shared exponent floating point data type manager 105 can represent the subset of the plurality of floating point numbers using shared exponent floating point data type 200.

FIG. 6 illustrates an artificial intelligence (AI) accelerator according to some embodiments. In some cases, AI accelerator 600 may be used for machine learning workloads (e.g., training machine learning models, using machine learning models for inference, etc.). As such, AI accelerator 600 can support any number of machine learning data types. For example, AI accelerator 600 may support floating point data types as well as shared exponent floating point data types (e.g., floating data types where multiple floating point values are stored together, share a common exponent value, and each has its own separate mantissa value).

As shown, AI accelerator 600 includes matrix multiplication units 605a-m. Each of the matrix multiplication units 605a-m is configured to perform multiplication operations on matrices. As depicted in FIG. 6, matrix multiplication unit 605c includes dot product units 610a-n, 615a-n, 620a-n, and 625a-n. Here, each of the dot product units 610a-n, 615a-n, 620a-n, and 625a-n includes system 100. In this example, each of the other matrix multiplication units 605a-m can be implemented in the same or similar manner as matrix multiplication unit 605c.

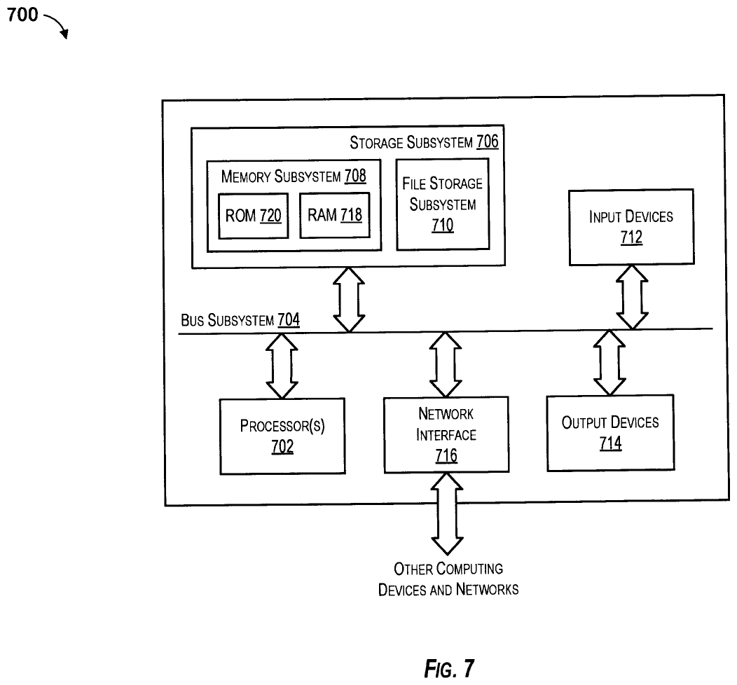

The techniques described above may be implemented in a wide range of computer systems configured to process neural networks. FIG. 7 depicts a simplified block diagram of an example computer system 700, which can be used to implement the techniques described in the foregoing disclosure (e.g., computing system 100). As shown in FIG. 7, computer system 700 includes one or more processors 702 that communicate with a number of peripheral devices via a bus subsystem 704. These peripheral devices may include a storage subsystem 706 (e.g., comprising a memory subsystem 708 and a file storage subsystem 710) and a network interface subsystem 716. Some computer systems may further include user interface input devices 712 and/or user interface output devices 714.

Bus subsystem 704 can provide a mechanism for letting the various components and subsystems of computer system 700 communicate with each other as intended. Although bus subsystem 704 is shown schematically as a single bus, alternative embodiments of the bus subsystem can utilize multiple busses.

Network interface subsystem 716 can serve as an interface for communicating data between computer system 700 and other computer systems or networks. Embodiments of network interface subsystem 716 can include, e.g., Ethernet, a Wi-Fi and/or cellular adapter, a modem (telephone, satellite, cable, ISDN, etc.), digital subscriber line (DSL) units, and/or the like.

Storage subsystem 706 includes a memory subsystem 708 and a file/disk storage subsystem 710. Subsystems 708 and 710 as well as other memories described herein are examples of non-transitory computer-readable storage media that can store executable program code and/or data that provide the functionality of embodiments of the present disclosure.

Memory subsystem 708 includes a number of memories including a main random access memory (RAM) 718 for storage of instructions and data during program execution and a read-only memory (ROM) 720 in which fixed instructions are stored. File storage subsystem 710 can provide persistent (e.g., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 700 is illustrative and many other configurations having more or fewer components than system 700 are possible.

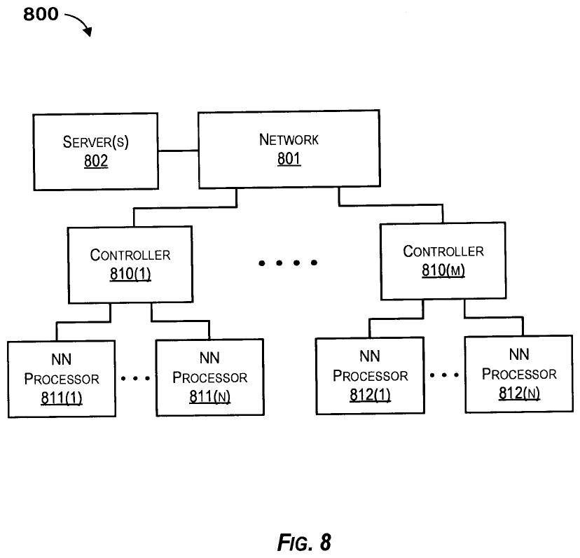

FIG. 8 illustrates a neural network processing system according to some embodiments. In various embodiments, neural networks according to the present disclosure may be implemented and trained in a hardware environment comprising one or more neural network processors. A neural network processor may refer to various graphics processing units (GPU) (e.g., a GPU for processing neural networks produced by Nvidia CorpR), field programmable gate arrays (FPGA) (e.g., FPGAs for processing neural networks produced by Xilinx R), or a variety of application specific integrated circuits (ASICs) or neural network processors comprising hardware architectures optimized for neural network computations, for example. In this example environment, one or more servers 802, which may comprise architectures illustrated in FIG. 7 above, may be coupled to a plurality of controllers 810(1)-810(M) over a communication network 801 (e.g., switches, routers, etc.). Controllers 810(1)-810(M) may also comprise architectures illustrated in FIG. 7 above. Each controller 810(1)-810(M) may be coupled to one or more NN processors, such as processors 811(1)-811(N) and 812(1)-812(N), for example. NN processors 811(1)-811(N) and 812(1)-812(N) may include a variety of configurations of functional processing blocks and memory optimized for neural network processing, such as training or inference. The NN processors are optimized for neural network computations. In some embodiments, each of the NN processors may be implemented by AI accelerator 600. Server 802 may configure controllers 810 with NN models as well as input data to the models, which may be loaded and executed by NN processors 811(1)-811(N) and 812(1)-812(N) in parallel, for example. Models may include layers and associated weights as described above, for example. NN processors may load the models and apply the inputs to produce output results. NN processors may also implement training algorithms described herein, for example.

### Further Example Embodiments

In various embodiments, the present disclosure includes systems, methods, and apparatuses for determining shared exponent values for shared exponent floating point data types. The techniques described herein may be embodied in non-transitory machine-readable medium storing a program executable by a computer system, the program comprising sets of instructions for performing the techniques described herein. In some embodiments, a system includes a set of processing units and a non-transitory machine-readable medium storing instructions that when executed by at least one processing unit in the set of processing units cause the at least one processing unit to perform the techniques described above. In some embodiments, the non-transitory machine-readable medium may be memory, for example, which may be coupled to one or more controllers or one or more artificial intelligence processors, for example.

The following techniques may be embodied alone or in different combinations and may further be embodied with other techniques described herein.

For example, in some embodiments, the techniques described herein relate to a method including: determining a shared global exponent value for a plurality of floating point numbers: determining a sub exponent value from a plurality of candidate sub exponent values that minimizes a quantization error value determined based on a subset of the plurality of floating point numbers and a version of the subset of the plurality of floating point numbers quantized based on the shared global exponent and the sub exponent value, wherein the determined sub exponent value is shared among the subset of the plurality of floating point numbers; and based on the sub exponent value, representing the subset of the plurality of floating point numbers using a shared exponent floating point data type, wherein representing, based on the sub exponent value, the subset of the plurality of floating point numbers using the shared exponent floating point data type results in higher numerical fidelity of the subset of the plurality of floating point numbers.

In some embodiments, the techniques described herein relate to a method further including: receiving the plurality of floating point numbers to be represented using the shared exponent floating point data type; and grouping the plurality of floating point numbers into a set of groups of floating point numbers, wherein the subset of the plurality of floating point numbers is a particular group of floating point numbers in the set of groups of floating point numbers, wherein representing the subset of the plurality of floating point numbers using the shared exponent floating point data type includes: generating an instance of the shared exponent floating point data type, wherein the instance of the shared exponent floating point data type is configured to store a plurality of mantissa values for the plurality of floating point numbers, a plurality of sign values for the plurality of floating point numbers, the shared global exponent value that is shared among the plurality of floating point numbers, and a set of shared sub exponent values, wherein each shared sub exponent value in the set of shared sub exponent values is shared among a group of floating point numbers in the set of groups of floating point numbers; and storing, in the instance of the shared exponent floating point data type, the determined sub exponent value as a shared sub exponent value in the set of shared sub exponent values for the particular group of floating point numbers.

In some embodiments, the techniques described herein relate to a method further including receiving an instance of the shared exponent floating point data type configured to store the plurality of floating point numbers, wherein the instance of the shared exponent floating point data type is configured to store a plurality of mantissa values for the plurality of floating point numbers, a plurality of sign values for the plurality of floating point numbers, the shared global exponent value that is shared among the plurality of floating point numbers, and a set of shared sub exponent values, wherein each shared sub exponent value in the set of shared sub exponent values is shared among a group of floating point numbers in a set of groups of floating point numbers, wherein the subset of the plurality of floating point numbers is a particular group of floating point numbers in the set of groups of floating point numbers, wherein representing the subset of the plurality of floating point numbers using the shared exponent floating point data type includes replacing, in the instance of the shared exponent floating point data type, the shared sub exponent value in the set of shared sub exponent values for the particular group of floating point numbers with the determined sub exponent value.

In some embodiments, the techniques described herein relate to a method, wherein the subset of the plurality of floating point numbers is a first subset of the plurality of floating point numbers, wherein the sub exponent value is a first sub exponent value, the method further including: determining a second sub exponent value from the plurality of candidate sub exponent values that minimizes a quantization error value determined based on a second subset of the plurality of floating point numbers and a version of the second subset of the plurality of floating point numbers quantized based on the shared global exponent value and the second sub exponent value, wherein the determined second sub exponent value is shared among the second subset of the plurality of floating point numbers; and based on the second sub exponent value, representing the second subset of the plurality of floating point numbers using the shared exponent floating point data type, wherein representing, based on the second sub exponent value, the second subset of the plurality of floating point numbers using the shared exponent floating point data type results in higher numerical fidelity of the second subset of the plurality of floating point numbers.

In some embodiments, the techniques described herein relate to a method further including, based on the shared global exponent value, adjusting each floating point number in the subset of the plurality of floating point numbers, wherein determining the sub exponent value from the plurality of candidate sub exponent values is based on the adjusted subset of the plurality of floating point numbers.

In some embodiments, the techniques described herein relate to a method, wherein adjusting each floating point number in the subset of the plurality of floating point numbers includes performing a set of right shift operations on a mantissa value of each floating point number in the subset of the plurality of floating point numbers.

In some embodiments, the techniques described herein relate to a method, wherein determining the sub exponent value from the plurality of candidate sub exponent values is based on a set of rules configured to, for a given set of adjusted floating point numbers, specify a particular sub exponent value that produces a smallest quantization error value.

In some embodiments, the techniques described herein relate to a method, wherein determining the sub exponent value from the plurality of candidate sub exponent values includes using the particular sub exponent value that produces the smallest quantization error value specified by the set of rules as the sub exponent value.

In some embodiments, the techniques described herein relate to a method, wherein the shared global exponent value and the determined sub exponent value are used together to represent an exponent of each floating point number in the subset of the plurality of floating point numbers.

In some embodiments, the techniques described herein relate to a hardware accelerator including: a first circuit configured to determine a shared global exponent value for a plurality of floating point numbers: a second circuit configured to determine a sub exponent value from a plurality of candidate sub exponent values that minimizes a quantization error value determined based on a subset of the plurality of floating point numbers and a version of the subset of the plurality of floating point numbers quantized based on the shared global exponent and the sub exponent value, wherein the determined sub exponent value is shared among the subset of the plurality of floating point numbers; and a third circuit configured to, based on the sub exponent value, represent the subset of the plurality of floating point numbers using a shared exponent floating point data type, wherein representing, based on the sub exponent value, the subset of the plurality of floating point numbers using the shared exponent floating point data type results in higher numerical fidelity of the subset of the plurality of floating point numbers.

In some embodiments, the techniques described herein relate to a hardware accelerator, wherein the third circuit is further configured to: receive the plurality of floating point numbers to be represented using the shared exponent floating point data type; and group the plurality of floating point numbers into a set of groups of floating point numbers, wherein the subset of the plurality of floating point numbers is a particular group of floating point numbers in the set of groups of floating point numbers, wherein representing the subset of the plurality of floating point numbers using the shared exponent floating point data type includes: generating an instance of the shared exponent floating point data type, wherein the instance of the shared exponent floating point data type is configured to store a plurality of mantissa values for the plurality of floating point numbers, a plurality of sign values for the plurality of floating point numbers, the shared global exponent value that is shared among the plurality of floating point numbers, and a set of shared sub exponent values, wherein each shared sub exponent value in the set of shared sub exponent values is shared among a group of floating point numbers in the set of groups of floating point numbers; and storing, in the instance of the shared exponent floating point data type, the determined sub exponent value as a shared sub exponent value in the set of shared sub exponent values for the particular group of floating point numbers.

In some embodiments, the techniques described herein relate to a hardware accelerator, wherein the third circuit is further configured to receive an instance of the shared exponent floating point data type configured to store the plurality of floating point numbers, wherein the instance of the shared exponent floating point data type is configured to store a plurality of mantissa values for the plurality of floating point numbers, a plurality of sign values for the plurality of floating point numbers, the shared global exponent value that is shared among the plurality of floating point numbers, and a set of shared sub exponent values, wherein each shared sub exponent value in the set of shared sub exponent values is shared among a group of floating point numbers in a set of groups of floating point numbers, wherein the subset of the plurality of floating point numbers is a particular group of floating point numbers in the set of groups of floating point numbers, wherein representing the subset of the plurality of floating point numbers using the shared exponent floating point data type includes replacing, in the instance of the shared exponent floating point data type, the shared sub exponent value in the set of shared sub exponent values for the particular group of floating point numbers with the determined sub exponent value.

In some embodiments, the techniques described herein relate to a hardware accelerator, wherein the subset of the plurality of floating point numbers is a first subset of the plurality of floating point numbers, wherein the sub exponent value is a first sub exponent value, wherein the second circuit is further configured to determine a second sub exponent value from the plurality of candidate sub exponent values that minimizes a quantization error value determined based on a second subset of the plurality of floating point numbers and a version of the second subset of the plurality of floating point numbers quantized based on the shared global exponent value and the second sub exponent value, wherein the determined second sub exponent value is shared among the second subset of the plurality of floating point numbers; and wherein the second circuit is further configured to, based on the second sub exponent value, represent the second subset of the plurality of floating point numbers using the shared exponent floating point data type, wherein representing, based on the second sub exponent value, the second subset of the plurality of floating point numbers using the shared exponent floating point data type results in higher numerical fidelity of the second subset of the plurality of floating point numbers.

In some embodiments, the techniques described herein relate to a hardware accelerator, wherein the second circuit is further configured to, based on the shared global exponent value, adjust each floating point number in the subset of the plurality of floating point numbers, wherein determining the sub exponent value from the plurality of candidate sub exponent values is based on the adjusted subset of the plurality of floating point numbers.

In some embodiments, the techniques described herein relate to a hardware accelerator, wherein adjusting each floating point number in the subset of the plurality of floating point numbers includes performing a set of right shift operations on a mantissa value of each floating point number in the subset of the plurality of floating point numbers.

In some embodiments, the techniques described herein relate to a hardware accelerator, wherein determining the sub exponent value from the plurality of candidate sub exponent values is based on a set of rules configured to, for a given set of adjusted floating point numbers, specify a particular sub exponent value that produces a smallest quantization error value.

In some embodiments, the techniques described herein relate to a hardware accelerator, wherein determining the sub exponent value from the plurality of candidate sub exponent values includes using the particular sub exponent value that produces the smallest quantization error value specified by the set of rules as the sub exponent value.

In some embodiments, the techniques described herein relate to a hardware accelerator, wherein the shared global exponent value and the determined sub exponent value are used together to represent an exponent of each floating point number in the subset of the plurality of floating point numbers.

In some embodiments, the techniques described herein relate to a non-transitory machine-readable medium storing a program executable by at least one processing unit of a device, the program including sets of instructions for: determining a shared global exponent value for a plurality of floating point numbers: determining a sub exponent value from a plurality of candidate sub exponent values that minimizes a quantization error value determined based on a subset of the plurality of floating point numbers and a version of the subset of the plurality of floating point numbers quantized based on the shared global exponent and the sub exponent value, wherein the determined sub exponent value is shared among the subset of the plurality of floating point numbers; and based on the sub exponent value, representing the subset of the plurality of floating point numbers using a shared exponent floating point data type, wherein representing, based on the sub exponent value, the subset of the plurality of floating point numbers using the shared exponent floating point data type results in higher numerical fidelity of the subset of the plurality of floating point numbers.

In some embodiments, the techniques described herein relate to a non-transitory machine-readable medium, wherein the program further includes sets of instructions for: receiving the plurality of floating point numbers to be represented using the shared exponent floating point data type; and grouping the plurality of floating point numbers into a set of groups of floating point numbers, wherein the subset of the plurality of floating point numbers is a particular group of floating point numbers in the set of groups of floating point numbers, wherein representing the subset of the plurality of floating point numbers using the shared exponent floating point data type includes: generating an instance of the shared exponent floating point data type, wherein the instance of the shared exponent floating point data type is configured to store a plurality of mantissa values for the plurality of floating point numbers, a plurality of sign values for the plurality of floating point numbers, the shared global exponent value that is shared among the plurality of floating point numbers, and a set of shared sub exponent values, wherein each shared sub exponent value in the set of shared sub exponent values is shared among a group of floating point numbers in the set of groups of floating point numbers; and storing, in the instance of the shared exponent floating point data type, the determined sub exponent value as a shared sub exponent value in the set of shared sub exponent values for the particular group of floating point numbers. Determining Shared Exponent Values for Shared Exponent Floating Point Data Types

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

What is claimed is:

1. A method comprising:
determining a shared global exponent value for a plurality of floating point numbers;
determining a sub exponent value from a plurality of candidate sub exponent values that minimizes a quantization error value determined based on a subset of the plurality of floating point numbers and a version of the subset of the plurality of floating point numbers quantized based on the shared global exponent and the sub exponent value, wherein the determined sub exponent value is shared among the subset of the plurality of floating point numbers; and
based on the sub exponent value, representing the subset of the plurality of floating point numbers using a shared exponent floating point data type,
wherein representing, based on the sub exponent value, the subset of the plurality of floating point numbers using the shared exponent floating point data type results in higher numerical fidelity of the subset of the plurality of floating point numbers.

2. The method of claim 1 further comprising:
receiving the plurality of floating point numbers to be represented using the shared exponent floating point data type; and
grouping the plurality of floating point numbers into a set of groups of floating point numbers, wherein the subset of the plurality of floating point numbers is a particular group of floating point numbers in the set of groups of floating point numbers,
wherein representing the subset of the plurality of floating point numbers using the shared exponent floating point data type comprises:
generating an instance of the shared exponent floating point data type, wherein the instance of the shared exponent floating point data type is configured to store a plurality of mantissa values for the plurality of floating point numbers, a plurality of sign values for the plurality of floating point numbers, the shared global exponent value that is shared among the plurality of floating point numbers, and a set of shared sub exponent values, wherein each shared sub exponent value in the set of shared sub exponent values is shared among a group of floating point numbers in the set of groups of floating point numbers; and
storing, in the instance of the shared exponent floating point data type, the determined sub exponent value as a shared sub exponent value in the set of shared sub exponent values for the particular group of floating point numbers.

3. The method of claim 1 further comprising receiving an instance of the shared exponent floating point data type configured to store the plurality of floating point numbers, wherein the instance of the shared exponent floating point data type is configured to store a plurality of mantissa values for the plurality of floating point numbers, a plurality of sign values for the plurality of floating point numbers, the shared global exponent value that is shared among the plurality of floating point numbers, and a set of shared sub exponent values, wherein each shared sub exponent value in the set of shared sub exponent values is shared among a group of floating point numbers in a set of groups of floating point numbers, wherein the subset of the plurality of floating point numbers is a particular group of floating point numbers in the set of groups of floating point numbers,
wherein representing the subset of the plurality of floating point numbers using the shared exponent floating point data type comprises replacing, in the instance of the shared exponent floating point data type, the shared sub exponent value in the set of shared sub exponent values for the particular group of floating point numbers with the determined sub exponent value.

4. The method of claim 1, wherein the subset of the plurality of floating point numbers is a first subset of the plurality of floating point numbers, wherein the sub exponent value is a first sub exponent value, the method further comprising:
determining a second sub exponent value from the plurality of candidate sub exponent values that minimizes a quantization error value determined based on a second subset of the plurality of floating point numbers and a version of the second subset of the plurality of floating point numbers quantized based on the shared global exponent value and the second sub exponent value, wherein the determined second sub exponent value is shared among the second subset of the plurality of floating point numbers; and
based on the second sub exponent value, representing the second subset of the plurality of floating point numbers using the shared exponent floating point data type,
wherein representing, based on the second sub exponent value, the second subset of the plurality of floating point numbers using the shared exponent floating point data type results in higher numerical fidelity of the second subset of the plurality of floating point numbers.

5. The method of claim 1 further comprising, based on the shared global exponent value, adjusting each floating point number in the subset of the plurality of floating point numbers, wherein determining the sub exponent value from the plurality of candidate sub exponent values is based on the adjusted subset of the plurality of floating point numbers.

6. The method of claim 5, wherein adjusting each floating point number in the subset of the plurality of floating point numbers comprises performing a set of right shift operations on a mantissa value of each floating point number in the subset of the plurality of floating point numbers.

7. The method of claim 5, wherein determining the sub exponent value from the plurality of candidate sub exponent values is based on a set of rules configured to, for a given set of adjusted floating point numbers, specify a particular sub exponent value that produces a smallest quantization error value.

8. The method of claim 7, wherein determining the sub exponent value from the plurality of candidate sub exponent values comprises using the particular sub exponent value that produces the smallest quantization error value specified by the set of rules as the sub exponent value.

9. The method of claim 1, wherein the shared global exponent value and the determined sub exponent value are used together to represent an exponent of each floating point number in the subset of the plurality of floating point numbers.

10. A hardware accelerator comprising:
a first circuit configured to determine a shared global exponent value for a plurality of floating point numbers;
a second circuit configured to determine a sub exponent value from a plurality of candidate sub exponent values that minimizes a quantization error value determined based on a subset of the plurality of floating point numbers and a version of the subset of the plurality of floating point numbers quantized based on the shared global exponent and the sub exponent value, wherein the determined sub exponent value is shared among the subset of the plurality of floating point numbers; and
a third circuit configured to, based on the sub exponent value, represent the subset of the plurality of floating point numbers using a shared exponent floating point data type,
wherein representing, based on the sub exponent value, the subset of the plurality of floating point numbers using the shared exponent floating point data type results in higher numerical fidelity of the subset of the plurality of floating point numbers.

11. The hardware accelerator of claim 10, wherein the third circuit is further configured to:
receive the plurality of floating point numbers to be represented using the shared exponent floating point data type; and
group the plurality of floating point numbers into a set of groups of floating point numbers, wherein the subset of the plurality of floating point numbers is a particular group of floating point numbers in the set of groups of floating point numbers,
wherein representing the subset of the plurality of floating point numbers using the shared exponent floating point data type comprises:
generating an instance of the shared exponent floating point data type, wherein the instance of the shared exponent floating point data type is configured to store a plurality of mantissa values for the plurality of floating point numbers, a plurality of sign values for the plurality of floating point numbers, the shared global exponent value that is shared among the plurality of floating point numbers, and a set of shared sub exponent values, wherein each shared sub exponent value in the set of shared sub exponent values is shared among a group of floating point numbers in the set of groups of floating point numbers; and
storing, in the instance of the shared exponent floating point data type, the determined sub exponent value as a shared sub exponent value in the set of shared sub exponent values for the particular group of floating point numbers.

12. The hardware accelerator of claim 10, wherein the third circuit is further configured to receive an instance of the shared exponent floating point data type configured to store the plurality of floating point numbers, wherein the instance of the shared exponent floating point data type is configured to store a plurality of mantissa values for the plurality of floating point numbers, a plurality of sign values for the plurality of floating point numbers, the shared global exponent value that is shared among the plurality of floating point numbers, and a set of shared sub exponent values, wherein each shared sub exponent value in the set of shared sub exponent values is shared among a group of floating point numbers in a set of groups of floating point numbers, wherein the subset of the plurality of floating point numbers is a particular group of floating point numbers in the set of groups of floating point numbers,
wherein representing the subset of the plurality of floating point numbers using the shared exponent floating point data type comprises replacing, in the instance of the shared exponent floating point data type, the shared sub exponent value in the set of shared sub exponent values for the particular group of floating point numbers with the determined sub exponent value.

13. The hardware accelerator of claim 10, wherein the subset of the plurality of floating point numbers is a first subset of the plurality of floating point numbers, wherein the sub exponent value is a first sub exponent value,
wherein the second circuit is further configured to determine a second sub exponent value from the plurality of candidate sub exponent values that minimizes a quantization error value determined based on a second subset of the plurality of floating point numbers and a version of the second subset of the plurality of floating point numbers quantized based on the shared global exponent value and the second sub exponent value, wherein the determined second sub exponent value is shared among the second subset of the plurality of floating point numbers; and
wherein the second circuit is further configured to, based on the second sub exponent value, represent the second subset of the plurality of floating point numbers using the shared exponent floating point data type,
wherein representing, based on the second sub exponent value, the second subset of the plurality of floating point numbers using the shared exponent floating point data type results in higher numerical fidelity of the second subset of the plurality of floating point numbers.

14. The hardware accelerator of claim 10, wherein the second circuit is further configured to, based on the shared global exponent value, adjust each floating point number in the subset of the plurality of floating point numbers, wherein determining the sub exponent value from the plurality of candidate sub exponent values is based on the adjusted subset of the plurality of floating point numbers.

15. The hardware accelerator of claim 14, wherein adjusting each floating point number in the subset of the plurality of floating point numbers comprises performing a set of right shift operations on a mantissa value of each floating point number in the subset of the plurality of floating point numbers.

16. The hardware accelerator of claim 14, wherein determining the sub exponent value from the plurality of candidate sub exponent values is based on a set of rules configured to, for a given set of adjusted floating point numbers, specify a particular sub exponent value that produces a smallest quantization error value.

17. The hardware accelerator of claim 6, wherein determining the sub exponent value from the plurality of candidate sub exponent values comprises using the particular sub exponent value that produces the smallest quantization error value specified by the set of rules as the sub exponent value.

18. The hardware accelerator of claim 10, wherein the shared global exponent value and the determined sub exponent value are used together to represent an exponent of each floating point number in the subset of the plurality of floating point numbers.

19. A non-transitory machine-readable medium storing a program executable by at least one processing unit of a device, the program comprising sets of instructions for:
determining a shared global exponent value for a plurality of floating point numbers;
determining a sub exponent value from a plurality of candidate sub exponent values that minimizes a quantization error value determined based on a subset of the plurality of floating point numbers and a version of the subset of the plurality of floating point numbers quantized based on the shared global exponent and the sub exponent value, wherein the determined sub exponent value is shared among the subset of the plurality of floating point numbers; and
based on the sub exponent value, representing the subset of the plurality of floating point numbers using a shared exponent floating point data type,
wherein representing, based on the sub exponent value, the subset of the plurality of floating point numbers using the shared exponent floating point data type results in higher numerical fidelity of the subset of the plurality of floating point numbers.

20. The non-transitory machine-readable medium of claim 19, wherein the program further comprises sets of instructions for:
receiving the plurality of floating point numbers to be represented using the shared exponent floating point data type; and
grouping the plurality of floating point numbers into a set of groups of floating point numbers, wherein the subset of the plurality of floating point numbers is a particular group of floating point numbers in the set of groups of floating point numbers,
wherein representing the subset of the plurality of floating point numbers using the shared exponent floating point data type comprises:
generating an instance of the shared exponent floating point data type, wherein the instance of the shared exponent floating point data type is configured to store a plurality of mantissa values for the plurality of floating point numbers, a plurality of sign values for the plurality of floating point numbers, the shared global exponent value that is shared among the plurality of floating point numbers, and a set of shared sub exponent values, wherein each shared sub exponent value in the set of shared sub exponent values is shared among a group of floating point numbers in the set of groups of floating point numbers; and
storing, in the instance of the shared exponent floating point data type, the determined sub exponent value as a shared sub exponent value in the set of shared sub exponent values for the particular group of floating point numbers.
